(19) United States
(12) Patent Application Publication
(10) Pub. No.: US 2024/0394658 A1
(43) Pub. Date: Nov. 28, 2024

(54) PRODUCT ORDERING SYSTEM BASED ON PROCESS DATA PROCESSING SYSTEM

(71) Applicant: Nanfu Wen, Beijing (CN)

(72) Inventor: Nanfu Wen, Beijing (CN)

(21) Appl. No.: 18/797,501

(22) Filed: Aug. 7, 2024

Related U.S. Application Data
(63) Continuation of application No. PCT/CN2023/074264, filed on Feb. 2, 2023.

(30) Foreign Application Priority Data
Feb. 8, 2022 (CN) 202210119695.X

(51) Int. Cl. G06Q 10/087; G06Q 30/0201; G06Q 30/0601; G06Q 50/04

(52) U.S. Cl. CPC G06Q 10/087; G06Q 30/0206; G06Q 30/0633; G06Q 50/04

(57) ABSTRACT

The present invention relates to a product ordering system based on a process data processing system, which for converting a resource library into actual production and operation for merchant and customer on the basis of a digital process flow template, a merchant module, a customer module, a custom manufacturing rule module, a basic template rule module. The customer module selects a digital process flow template from one of two paths, i.e., the template provided by the system or manufactured by the merchant, then sends the selected digital process flow template to the merchant module, a product order list is formed after logical relationship is verified. This process completes matching and pricing of the template selected by the customer and the template manufactured by the merchant, finally provides a customized product, guides real preparation, settlement and distribution, and provides user with formally delivered physical product that conforms to the digital product.

### CROSS REFERENCE TO RELATED APPLICATIONS

The present application is a Continuation Application of PCT Application No. PCT/CN2023/074264 filed on Feb. 2, 2023, which claims the benefit of Chinese Patent Application No. 202210119695.X filed on Feb. 8, 2022. All the above are hereby incorporated by reference in their entirety.

### FIELD OF TECHNOLOGY

The present invention belongs to the technical field of computer software application, specifically, to a product ordering system based on a process data processing system and matching with production and sales.

### BACKGROUND

The existing authorized CN111625562A “PROCESS DATA PROCESSING SYSTEM” records that through template design, information on raw materials and an operation of processing the raw material in each step is collected, and a product generated by a combination of multiple steps or a product produced by nested production finally give a clear digital product. Using the “PROCESS DATA PROCESSING SYSTEM”, the taste value and nutritional value of the product can also be obtained by setting the multi-dimensional and necessary correlation of the raw material and the operation. The technical information disclosed in the “PROCESS DATA PROCESSING SYSTEM” captures and manages a wide range of information related to raw materials, the operations, intermediate products, and final products. This data can be managed by a data management module, and can leveraged to create unique digital process flow templates, allowing for dynamic maintenance and updates tailored to specific products. The system is universal and can be used by any user facilitating high-dimensional information matching and serving as a resource library.

According to the above system, while the system excels in generating clear digital products, and accommodating continuous updates based on demand, it does not currently support actual manufacturing or sales processes. To address this, the integration of new functional modules is required to enable seamless production and sales capabilities. Further elaboration on this will be provided.

### SUMMARY

The present invention is designed to seamlessly integrate information modules related to production and sales based on the resource library mentioned above. By doing so, the system is empowered to provide comprehensive data information and advanced management tools for both production and sales.

The present invention provides the following technical solution.
1. A product ordering system based on a process data processing system. It includes a unique identifier digital process flow template. The digital process flow template creates an intermediate product and/or a product from raw materials and operations stepwise according to a step. the raw materials, operations and/or products are stored and maintained through a data management module and a data maintenance module; the logical relationship between raw materials and operations is clearly defined by a basic template rule module; and
further including a merchant module, a customer module, and a price module,
the merchant module includes production data information, basic information, management information, it also holds an intermediate product white list and/or a template white list of a merchant. The template white list includes a plurality of digital process flow templates that are capable of being prepared by the merchant;
In addition, the merchant module includes a custom manufacturing rule module, that defines of the logical relationship between the raw material and the operation by each specific merchant.

Within the customer module, a customer selects a digital process flow template from one of two paths, i.e., the digital process flow template of the system or the digital process flow template in the template white list of the merchant. The selected digital process flow template is then sent to the merchant module. The logical relationship is verified through the custom manufacturing rule module, and a product order list is generated as a result.

Furthermore, the system further includes a price module, which contains price information regarding raw materials and operations. The price information related to raw materials includes commodity price information, commodity pre-sale ordering information, commodity batch information, commodity supplier information, time-limited price information, and/or an on-demand quotation option; the price information related to operations includes basic operation pricing, personnel skill pricing, appliance use pricing, and/or special rule pricing; and the product order list is matched with the price information in the price module to form a preparable and payable production order.

A merchant can select a template from a resource library or upload a new template to create a template white list associated with the merchant. The same merchant can select different templates, and different merchants can select the same template.

Additionally, a user can select a template from the resource library, upload a new template, or choose a template from the template white list of the merchant.

When the user selects a template from the resource library or upload the new template, a custom manufacturing rule is performed for association matching. The custom manufacturing rule module includes definitions of raw materials and operations, as well as the logical relationship between them for each specific merchant, which can be set through a “rule black list” and/or a “rule white list”.

The digital process flow template forms a branch template after adjusting raw materials and/or operations. The branch template is directly sent to the merchant and verified only through the custom manufacturing rule module.

The merchant's production information includes a raw material white list, an appliance white list, an operation white list, and/or a personnel allocation list.

In the custom manufacturing rule module, a raw material includes three states: present, absent, or uncertain; while an operation is categorized as: doable, non-doable and uncertain.

The system further sets the intermediate product, the merchant module includes an intermediate product white list, and a certain digital process flow template selected by the user includes the intermediate product, and the system then prompts use of the intermediate product to accelerate a preparation process.

The customer module selects a certain digital process flow template in the system and sends the digital process flow template to the merchant. when the merchant lacks or only has a certain raw material, operation, intermediate product, and/or product, a reservation solution or a replacement solution is capable of being communicated with the customer through a customized service module, and based on a communication result, an order list is formed, where the reservation solution includes a reservation purchasing time interval of a missing item.

The price information further includes pricing information related to management, which is a charging item defined by the merchant and includes a peak hour markup fee, a delivery fee, a venue use fee, a packaging fee, a rent sharing fee, and/or a water and electricity use fee.

The basic template rule module is used to maintain the logical relationship between raw materials and operations, This involves classifying and grouping raw materials and/or operations, planning the raw material and/or the operation with similar attributes into a same set, prioritizing maintenance of a typical raw material and/or operation in the same set, and maintaining the logical relationship between the raw material and the operation, and a logical relationship between a raw material group and an operation group. In addition, combining an operation mode and the raw material includes whether it can be combined and an allowable range of a corresponding dimension of the operation after combination.

The present invention adds subdivided content on the basis of the previous one, and has the following obvious advantages.

First, the local or regional market can meet and match the concept of real preparable raw materials and processes. Based on this, the system of the present invention can provide a pure data service, which conducts market data analysis such as price comparison and supervision based on price information, thereby obtaining data such as an average price and the lowest price, providing pricing guidance for merchants, and providing clear and quick guidance for customers in commodity purchase on selection, such as providing corresponding intelligent recommendation information for matching of different specifications. For example, for the lowest price, when the same preparation template is selected, the corresponding raw materials and preparation processes, as well as locations and pickup time, etc. can be quickly matched and combined according to a lowest price calculation method, or for the best quality, corresponding content is intelligently matched by a platform according to different conventional cognitions.

To address the issue of the lack of standardization and clarity in the unified quotation of customized commodities, the present invention defines the relationship between the preparation and quotation of customized commodities by merchants, thus providing clear quotation information for merchants and consumers.

Second, the present invention can effectively match real inventory, personnel and manufacturing processes of merchants by providing real and complete raw material information and process flow information, and matching corresponding process flow templates, and truly guide real preparation, settlement and distribution through one-to-one corresponding digital process flow templates, and finally provide users with formally delivered physical products that conform to digital products.

### BRIEF DESCRIPTION OF THE DRAWINGS

FIG. 1 shows a schematic diagram of a product ordering system based on a process data processing system.

FIG. 2 shows a flow chart from creating a product ordering system template based on a process data processing system to generating a standardized order.

FIG. 3 shows a flow chart of a user completing a purchase by selecting a template for personalized customization.

FIG. 4 shows a flow chart of a user selecting a standard template and directly completing a purchase.

FIG. 5 shows a flow chart of a user completing a purchase by selecting a standard template and adding it to a shopping cart.

FIG. 6 shows a process flow chart from order generation to payment.

### DESCRIPTION OF THE EMBODIMENTS

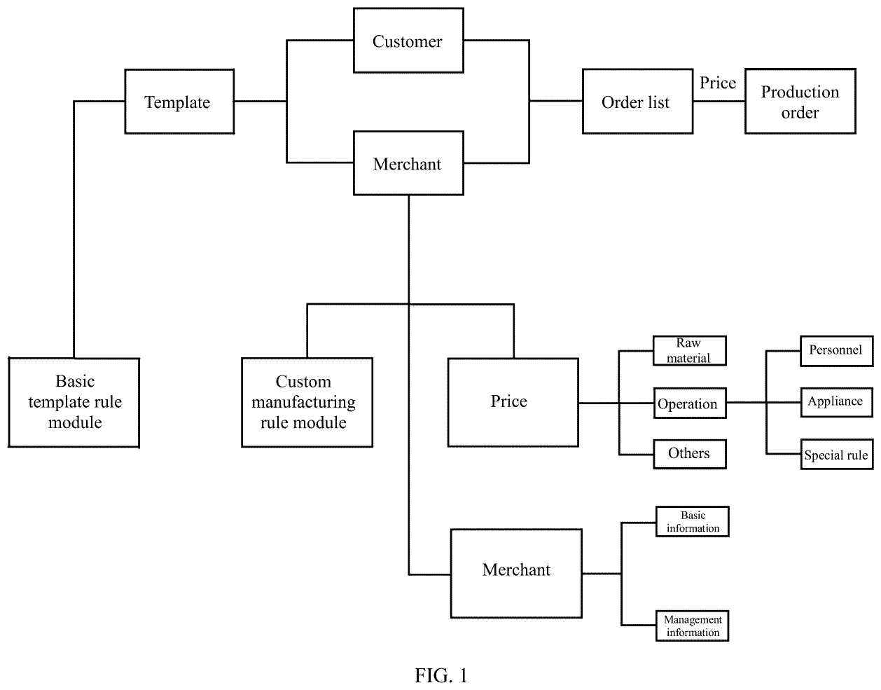

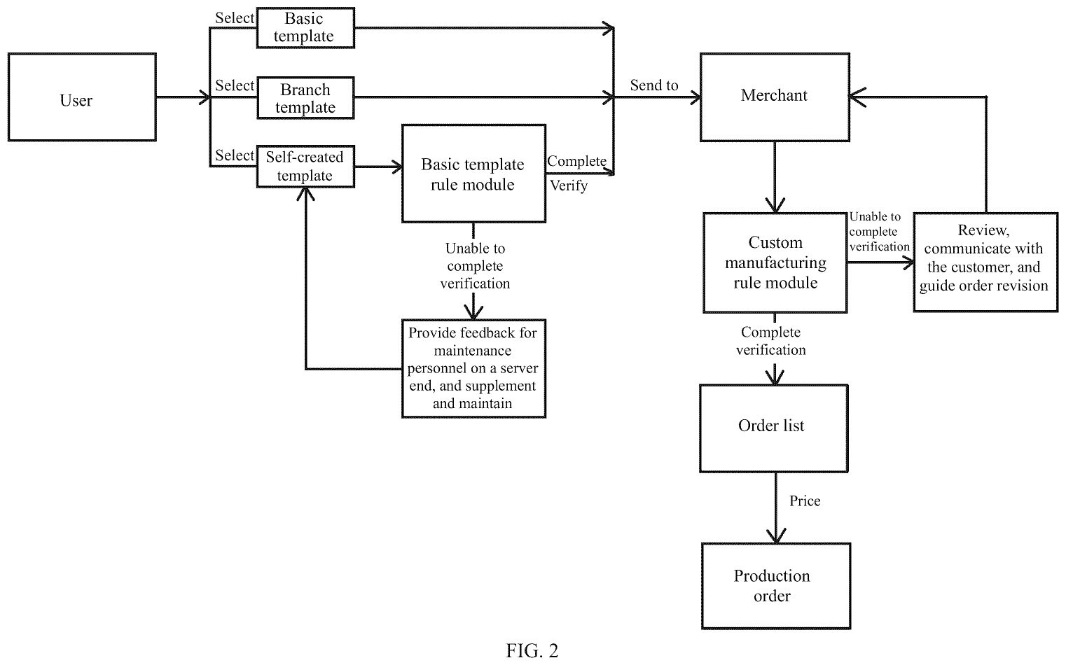

The present invention further provides a merchant module, a customer module, and a price module based on the digital process flow template (corresponding to a unique digital product, hereinafter referred to as a template) in the existing “PROCESS DATA PROCESSING SYSTEM”, as shown in FIGS. 1 and 2, where the price module provides price information associated with information such as a raw material and an operation, and the price information includes pricing information related to the raw material including commodity price information, and/or commodity batch information, and/or commodity supplier information, and/or time-limited price information, and/or an on-demand quotation option. A user can select one or a combination of functions according to an actual situation. For raw materials purchased in pieces or raw materials for which suppliers or batches do not have to be distinguished, commodity price information can be directly maintained. For raw materials with supplier information, supplier information, and corresponding commodity price information can be maintained. For commodities with different batches, the system can maintain commodity batch information. The time-limited price information generally corresponds to real-time fluctuations in raw material prices, including: price fluctuations existing at different times or price fluctuations based on inventory pressure. In the system, fluctuating prices can be defined by time and upper and lower limits. The on-demand quotation option is a reserved option in the system, which is set for some projects that require communication between both parties, that is, the option is set at a corresponding raw material level to prompt that the raw material can be used or purchased, but a quotation needs to be quoted separately in real time, and the quotation is completed through communication. For example, dishes that mainly use fresh fish have different specifications, and the price needs to be based on the weighing at the time of production. The on-demand quotation option can be set as: there are raw materials, but the quotation needs to be communicated.

A product provided by the merchants mainly includes four ways. The first is that the merchant can provide a product with a specific quotation. The second is that the merchant can provide a product without a specific quotation. The third is when the merchant does not deny that a product can be provided without a quotation (unknown option). The fourth is clearly stating that a product cannot be provided without a quotation.

In addition, the price information further includes pricing information related to the operation, and the pricing information includes basic operation pricing, personnel skill pricing, appliance use pricing, special rule pricing, and other pricing information that affects a price of a finished product. It can be reflected in aspects such as a labor costs, an appliance use fee, and special need pricing. Basic operation pricing generally refers to directly corresponding the operation with clear pricing information without distinguishing between personnel skills, equipment use and other special needs. For example, for stir-frying, only one basic operation pricing can be defined. For an operation with a high skill requirement, pricing based on a personnel skill rating can be used to limit pricing information corresponding to a corresponding operation implemented by such personnel. Similarly, pricing can be applied to use of an appliance to limit pricing information for operating with the appliance. When a special need is encountered, separate pricing can be performed for the special operation need to correspond to the special operation. The above pricing information corresponding to the operation can be applied individually or collectively.

In addition, the price information further includes pricing information related to management. For example, a peak hour markup fee, a delivery fee, a venue use fee, a packaging fee, and a fee due to differences in locations. The pricing information related to management can be associated with price information highly related to the finished product such as the raw material and the operation mentioned above. The peak hour markup fee is when the system sets a certain time range as a peak hour, a price needs to rise, a peak hour markup fee option is started, and a customer is asked whether to continue to choose. The pricing rule for the delivery fee is to set a benchmark price within a certain distance range, and an additional fee will be generated step by step if the distance range is exceeded. If a delivery is free for 3 kilometers and the price increases by 20% for every additional 1 kilometer, a customer is asked whether to continue to choose. For another example, the packaging fee can be a one-time quotation. The venue use fee (dine-in) can be set as an option and associated with a time range and a price range. Such content related to commercial management and affecting pricing information can be set through this system.

The above price information associated with the raw material, the operation, and other information is maintained by the merchant at a level of an existing specific raw material and operation. This system defines two roles: merchant and customer. The merchant is a preparation end and the customer is a purchaser. The system sets up the merchant module to match the needs of the merchant. The merchant will maintain its own production information, such as the raw material, the appliance, the personnel, and other information related to system data and related to actual production materials. This information can be associated and maintained at a relevant data level of the system and can be reflected as a raw material white list and an operation white list. The merchant will predefine a template white list, i.e., a plurality of digital process flow templates that the merchant can prepare. Of course, the merchant will also maintain its own basic information such as industrial and commercial registration information and management information such as a delivery scope, business hours, working hours, a rent sharing fee, and a water and electricity use fee. The system sets a customer module to match an ordering requirement, and the customer module can select between the digital process flow template provided by the system and the digital process flow template in the merchant and the template white list of the merchant.

According to an actual preparation process, the system can elaborate on the combination and application of an existing digital process flow template from two aspects each: customer (purchaser) and merchant (preparation end). First, the merchant (preparation end) can select a template based on the resource library or upload a new template to form a series of templates matched with the merchant, i.e. the template white list of the merchant. It needs to be emphasized again that the digital process flow template is unique in the resource library. A same merchant can select a different template, and a different merchant can also select a same template. The same merchant sets its own template white list for the user to select a product provided by the merchant. The purchaser can select a template from the template white list of the merchant and can also make fine tuning based on the template. Of course, the system can also provide another template selection method, that is, the purchaser directly selects the template from the resource library or customizes the template, and then sends the template to a certain merchant to negotiate pricing and complete purchase on selection. The fine-tuning and custom template of a selected template will be elaborated in detail in the following paragraphs.

The system of the present invention aims to associate a template of the nature of the resource library with the preparation and sale of a real commodity. That is, the customer can directly choose a template from the resource library or a template in the white list through the merchant. When the user selects a template, the template is automatically matched with the template provided by the merchant. Through automatic matching, the user will know whether there is uncertain or impossible process information in this process. If the user selects to continue, the selected template will be sent to the merchant. When the merchant obtains a product required by the customer, that is, the digital process flow template (digital product) selected by the system, the merchant will confirm how the digital product is prepared, whether the digital product can be prepared, how the digital product is priced, and whether manual intervention is needed. After a conclusion is reached, a complete solution is determined, and the content of communication can be executed with the agreement of the customer or after revision, or the product is prepared without a warranty with the authorization of the user. This patent helps the merchant determine whether the required product can be prepared through a digital method, and further matches the required product with the merchant's production material, ultimately achieving the purpose of guiding production, completing preparation, and selling.

However, the merchant can select a template, create a template, and ultimately establish its own template white list. However, the merchant does not have a direct editing right for information in the resource library and can only limit next-level information such as the raw material and the appliance in the resource library, such as a price of the raw material and a price of the appliance. If the merchant needs some special raw materials or special appliances, etc. that are not in the resource library, the merchant can apply to the system, and the system will maintain them in a database through an original data management template, that is, the function of template creation of the original “process data processing system” is used.

For the digital process flow template in the system, the system already includes the basic template rule module used to maintain the logical relationship between the raw materials and the operation. The basic template rule module classifies and/or groups the raw material and/or the operation, plans the raw material and/or the operation with similar attributes into a same set, prioritizes maintenance of a typical raw material and/or operation in the same set, and maintains the logical relationship between the raw material and the operation, and a logical relationship between a raw material group and an operation group. Combination of an operation mode (including a corresponding dimension range) and the raw material includes whether it can be combined and an allowable range of a corresponding dimension of the operation after combination. For example, whether the raw materials and the operation can be prepared, and whether a certain raw material group and a certain operation group can be prepared. It also includes an undefined rule state, which is similar to that no violation or scope relationship has been maintained between the raw material or the operation, and there is no unrestricted use of combinations (such as raw garlic and a minced operation). For example, the operation mode of combined frying of raw water and oil at 180 degrees Celsius is indicated as illegal content in a rule library, while the raw water and a heating operation will have a range limit of not exceeding 100 degrees Celsius under normal conditions. Overall, maintenance of rules in the template rule module is to maintain an association relationship between the raw material and the operation and between the raw material group and the operation group and provide a numerical limit range of an encountered operation dimension or a raw material dimension for the association relationship (dimension information is described correspondingly in prior patents).

To match actual management, the merchant module can also include the custom manufacturing rule module defined for the merchant based on the existing basic template rule module. The custom manufacturing rule module includes a restriction on the raw material and the operation of each specific merchant, to filter the template itself to determine a product that can be actually managed and sold to the user. For example, regarding whether the raw material has corresponding inventory or whether it can be purchased or allowed to be prepared in a short time, the raw material is divided into: present, absent or uncertain. Similarly, the operation is also divided into: doable, non-doable and uncertain. The raw material and the operation here include information related to actual production, such as the raw material, the personnel, the appliance, a special rule, and other restrictions at the above price definition. The merchant customizes its existing means of production, etc. When the customer selects a corresponding template and matches a corresponding merchant as a contractor, the customer can intuitively see a corresponding display, and the merchant can or cannot complete content of the corresponding template. Its purpose is to solve the problem that currently all merchants selling commodities basically sell goods in the form of finished products, but cannot flexibly complete the preparation of commodities that are more in line with user-defined content, and users actively initiate and select or create the digital templates (digital products that can be intuitively understood) that the users need to match the preparation capabilities of the merchants and ultimately quickly determine whether physical product preparation can be completed. If there are a variety of optional raw material supplier information or price information or alternative intermediate products, the system allows the user to select on its own. This selection may cause the product to be a pre-ordered product and cannot be prepared in time, or after communicating with the merchant or replacing the intermediate product, a verification is performed through the custom manufacturing rule module again. This does not involve changes in the main process here, and cycling is performed only at this step.

If it is an analogy between the raw material group and the operation group, it mainly involves the content selected by the user. Some rules are not maintained by the merchant, which can be considered as uncertain parts, and even determine whether there is a violation of a basic operation process, such as heating to 300 degrees Celsius. According to different situations, some correlation judgments are made and whether it is necessary to provide a relevant prompt for the user or the merchant is formed. The custom manufacturing rule module used by the merchant includes a form of a “rule blacklist” and/or a “rule white list”, which predetermines a list of rules that cannot be prepared and used. If low-temperature baking is allowed in the basic template rule module, but the merchant limits an allowed baking temperature to only be within a high-temperature range in the custom manufacturing rule module, the template selected by the user that includes low-temperature baking cannot pass a verification of the rule white list, and a result will be returned to the user for data adjustment.

The basic template rule module and the merchant custom manufacturing rule module can perform two verifications on the template selected by the customer to determine whether the selected template can be prepared.

As mentioned above, the customer module can select between templates from the resource library or templates from the template white list in the merchant module. This system provides two template selection paths. The first is that the customer selects a template through the template white list of the merchant. The second is that the customer directly selects a template from the resource library. If there is no desirable template, the customer first creates its own template, uploads it to the resource library, then selects it, and finally submits a selected template to the merchant, that is, the user selects a template independently. In the process of forming a template and selecting a template and sending it to the merchant, a product order list is finally formed through a two-level rule verification, and the product order list matches a price defined by the merchant. After communication with the merchant, a preparable and payable production order is finally formed.

In addition, from the user's perspective, there are three ways to select a template. The first is to select a template directly if it is available in the system. The second is that there are similar templates in the system, and a template can be selected and fine-tuned later. The third is that there is no such template in the system, and the user creates its own template. If there is an existing standard template that has been verified by the platform based on the basic template rule module during a template creation process, the template will be directly sent to the merchant (producer) for a secondary rule verification through the custom manufacturing rule module on a merchant end. After the merchant confirms that the template can be manufactured, the price information provided by the price module is matched to form a preparable and payable production order.

If there is a self-created template (which can be self-created by both the customer and the merchant) or a fine-tuned template, the platform needs to verify the template through the basic template rule module to see if there are any rules that cannot be implemented. If there are no rules that cannot be implemented by the platform, the template will be sent to the merchant, and the custom manufacturing rule module on the merchant end will determine whether the template violates custom manufacturing rules of the merchant. If there are no violations, an executable standardized order list will be generated and sent to a specific producer (merchant), and the custom manufacturing rule module on a producer end will review the order and provide feedback. If the template violates rules in the basic template rule module of the platform, the user is required to modify content that cannot be prepared regularly; and when the user has objections, feedback is provided for maintenance personnel on a server end to supplement and maintain corresponding rules. If the corresponding template violates custom rules of the merchant, the user can communicate and negotiate with the merchant. That is, a final order template of the user is adjusted to meet preparation requirements of the merchant, or the merchant prepares a template according to reasonable needs put forward by the user, or selects the merchant who can prepare the template for preparation.

In the above second way, the user makes adjustment based on the selected template, and forms a corresponding branch template without changing the basic standard template. The branch template is an independent template formed after adjusting the existing template, and the branch template is formed after revising the raw material or the operation. The template does not need to verify related similarity of the original template. It should be noted that when the user or the merchant creates a template, the system has template similarity judgment, and a template with high similarity cannot be uploaded due to the uniqueness setting of the template. At the same time, such branch templates are divided into fundamental adjustment and non-fundamental adjustment. Content of the non-fundamental adjustment includes fine-tuning of the raw material and/or the operation. Corresponding adjusted data can quickly pass through a “rule black list” (a list of rules that cannot be prepared and used) of the system. If there are no special rules that cannot be prepared, the template can be sent to a preparation end for matching verification. Such branch templates can be pushed to the preparation end, and the system will determine whether the preparation end has corresponding production materials and manual skills, and whether the preparation end can complete the preparation. The fundamental adjustment is equivalent to a “template that is uncertain whether it can be prepared”, which belongs to the third way.

The third way is: the user proposes a custom template, that is, creates a template, which can edit and create information such as the raw material and/or the operation and/or the appliance in the digital process flow template. Subsequently, a manufacturer is selected based on template creation and then corresponding real production materials are matched for production preparation. Therefore, it is divided into two stages here, first creating a template, and then matching production materials of a preparation party. The template creation is the content of the “process data processing system”. During the creation process, the basic template rule module is used to verify relevant definition content to determine if there are any rules that cannot be defined. If there are no rules that cannot be defined, further matching can be done with the preparation end, verification is performed through the custom manufacturing rule module of the merchant, no illegal content is involved, and an executable standardized order list is generated and sent to the preparation end. If there is content or rules that do not exist in the database, relevant requirements will be pushed to relevant maintenance personnel, and the maintenance personnel will supplement and maintain the corresponding rules. Most of the content will be automatically compared by the system through a corresponding operation mode and usable items within maximum value and minimum value ranges corresponding to collocation of raw materials to form a custom template. Please refer to FIG. 1 and FIG. 2.

The preparation end (also known as the production end, etc.) can be a factory, a store, or an individual vendor, an industrial chain system formed by a combination of different merchants, etc., which can be docked with data, such as providing production material, personnel, appliance, and raw material inventory information, etc. to perform rapid data matching, so as to realize multi-terminal cooperation of real product preparation and processing. In detail, the preparation end mainly defines the following three points:
1. basic information and management information of the merchant, which have been elaborated in detail in the first part of the introduction.
2. price information, including that of the raw material and the operation, which has been elaborated in detail in the first part of the introduction. Based on a template determined by the user, corresponding information such as the raw material, the operation, the intermediate product, the product, the price can generally be determined or supplemented in real time. On this basis, it can further correlate summary data information such as order time, supply time, whether it is a peak time period, and the delivery fee.
3. digital process flow template, which can prepare the template white list, the raw material white list, the intermediate product white list, the appliance white list, the operation white list, the personnel allocation list, and/or the custom manufacturing rule module of the merchant. The merchant can not only define the template white list, but also define the raw material white list and the intermediate product white list, with a purpose of further meeting a customized need of the user on the basis of meeting basic business. By digitizing skills and craftsmanship of production personnel into a series of process operations, digital management of the personnel is performed. By controlling a digital process of equipment and personnel, it is possible to calculate how many devices and how many operators can be used during a same time period. The digital process flow template can be customized and uploaded by the merchant, or an existing digital process flow template provided by other merchants can be used or purchased. In order to ensure stable output, most of the digital process flow template of a same merchant can usually be a standard template. The system can set: based on an increment or a decrement of a certain element in the template white list, steps can also be appropriately reduced. If a substantial modification is made, the system will determine whether it belongs to a same type of custom rules and whether it can be continued. If it can be continued, an executable process flow template will be generated. If it cannot be executed, feedback will be given to maintenance personnel to maintain new rules in the system, and then a corresponding process flow template can be formed. Then it is confirmed whether a completed process flow template can be prepared through communication between the user and the merchant. As mentioned earlier, the template can be customized by the merchant, or an existing template created by other merchants can be purchased.

The user can see the product white list in the system and locate a merchant through the product white list. In addition, the following operations can be performed:
The first: directly selecting the product white list after selecting a merchant, and producing an executable standardized order list and sending it to the merchant for preparation by the system. The merchant can be defined as completely unable to provide any changes and only offering standard products.
The second: making personalized modifications based on the selected product white list, such as not adding/adding more/adding less chili pepper, so as to make small-scale adjustments. The system matches the merchant according to corresponding customized requirements. The merchant has a corresponding raw material list, equipment and personnel in a background to meet a requirement that the product can be prepared, but it is necessary to ask the merchant whether the product can be manufactured and what a manufacturing fee is. A feedback message from the merchant interacts with the user, and an executable standardized order is determined according to a communication result and sent to the merchant for preparation.
The third: making personalized modifications are made based on the selected product white list, and matching the merchant according to corresponding customization requirements by the system. The merchant lacks necessary raw materials, but can provide reservation and customization service modules. It is necessary to ask the merchant about the time and fee of providing products, interact with the user, determine an executable standardized order according to a communication result, and send it to the merchant.

According to data of the platform, the user can quickly determine which products can be provided by which merchants immediately, and which products need time to be customized by which merchants. For example, if a purchased product has been prepared, a preparation link before an operation link can be omitted, and if there is no preparation, it is necessary to start from scratch. In this way, the raw material and the operation are combined to perform forward and reverse matching.

If the product selected by the user is not a product that a certain merchant can provide on the white list and the user still wishes to be able to pick the product up from this merchant, it depends on whether this merchant can customize and produce the product for the user. For example, a certain merchant only sets fish-flavored shredded pork made of pork in the white list, while its inventory also has chicken, and chicken can also be used to make fish-flavored shredded pork. When the user wishes to have fish-flavored shredded pork made of chicken, the system will match it and feed it back to the merchant through prompts to ask whether it can be prepared.

The user can also propose a special raw material or process list and a special product different from the provided template, and the preparation end can purchase it separately in order to meet special needs of a user end. The complete process and information of individual procurement will be fed back into the system, and finally a suitable price and a supplier who can provide corresponding raw materials will be calculated and determined. It can be retrieved from suppliers entered in this region, or it may need to be retrieved across regions, or it may be purchased internationally, etc. Even if this information is not included in the template, the information can be added through a customization function of the template to ensure that when a generated template is handed over to the supplier (which is the preparation end at this time), the preparation end in the process will definitely be able to obtain a detailed executable production list.

This system also includes time management and planning functions to provide guidance for the preparation process of the preparation end. Only when the raw material in the inventory is complete and the operation is controllable, can preparation be carried out, and can when a final finished product can be supplied to the customer end be determined. In this way, the production time and delivery process of the entire product can also be clearly defined. For example, if a restaurant is busy during three meal periods in a day, making a reservation in advance can prioritize certain links and ensure that final supply is less stressful, allowing for smooth and timely completion of delivery.

Regarding the definition of time, sales time and manufacturing process time, etc. can also be set. The sales time (business hours) belongs to the front desk, while the manufacturing process time belongs to the back desk. The manufacturing process time can include manual working time and social working time, and can also be set according to needs. Ready-made intermediate products (semi-finished products) only need to consider logistics time, while customized products need to consider all the time from raw materials to manufacturing and ordering, etc. This time is based on the entire process, so its cycle cannot be clearly defined. For example, the business hours of physical stores are from 10 a.m. to 10 p.m., while factory production time, transportation logistics time, and matching time to the stores may vary. All the time needs to be matched to determine when customers can obtain products. For small-scale or relatively scattered preparation ends, a specific time management system may not be needed, and all the time may be judged manually, but for large-scale production such as factories, time issues must be considered.

When the user selects a commodity, whether through commodity search or merchant search, there are three situations: the first is that the commodity (i.e. its process flow template) is already in the white list of the merchant and can be provided; the second is that although the commodity is not in the product white list, the merchant can complete manufacturing of the product and have a list of corresponding equipment and raw materials; and the third is that there are several items in a commodity preparation template that are not currently available, and the merchant can make an appointment to purchase and directly enter a customized service module option. The fourth situation is that a selected template cannot match a corresponding merchant for preparation, and its process information cannot be queried for a valid order within a selected matching range. At this situation, it is not sure whether the user will see corresponding information. Of course, if there are no matching results at all, a prompt will be given that “this service is temporarily unavailable in this region”.

In the first situation, the merchant can customize a price for a commodity on the white list because the product is a regular commodity with fair and reasonable pricing, which is lower than customization. The second is that the merchant has inventory and raw materials that can manufacture a product, but they need to be priced separately, and customized prices can be formed by setting rules. Because for a customized product, when the user does not put forward a clear demand, the merchant cannot effectively estimate a corresponding cost and give a quotation.

For the first situation, the product can be directly prepared and produced after the user places an order. The second situation is that the user needs to communicate with the merchant and inquire whether it can provide a related product. The third situation will be more complex. After communication, the merchant can also provide a related product, and the user can give the merchant time to prepare relevant raw materials and equipment by making an appointment. For example, the merchant purchases raw materials separately according to the reservation time and requirements. The price of this service is relatively higher and the process is longer. If the merchant believes that it can accept the order after a system inquiry, it will start a product reservation module and provide information on required time and a fee. The platform then feeds this information back to the user, the user is asked if it agrees with this, and whether to place an order is finally selected.

There are two types of user searches: one is to directly search for a commodity, and through the commodity, the user can view a merchant who supplies it; and another option is for the user to directly search for a merchant and select a commodity that the merchant can provide. These are two completely different paths. For example, the user can directly search for a commodity regardless of which merchant provides the commodity. A same commodity can match multiple merchants, and then one of the merchants can be selected and the commodity on a white list that the merchant can provide. In this situation (due to a setting of the merchant), the system will display a price of the corresponding commodity. The user can also specify a merchant first, and then the system will push the order to the merchant. The user can view and select a commodity on a white list of the merchant, or make some simple customizations for a commodity (such as increasing/decreasing/not adding chili pepper to food), or make an inquiry about a commodity not in the white list to ask whether the commodity can be customized.

Alternatively, for another example, the user selects multiple products, but multiple commodities are not necessarily in a same merchant. The user wants to place an order together in the same merchant, but there is no single merchant that can provide all these products. In this case, the system will match which merchants are available for selection, and then the system will ask the merchants if a product that is not on their white list can be prepared. Multiple merchants that can prepare the product quote the total price/time/pickup place, etc. at the same time, and then this is fed back to the user for judgment and selection.

There are two paths that the user can select from. The first path is to directly select a merchant, and the merchant can provide three services. The first is a white list service. The second is that the product is not on the white list but can be manufactured. The third is a customized service. The second path is to directly select a product and choose a merchant through the commodity, and the merchant can provide the above three services for selection. Appropriate fine-tuning can also be made in the white list service.

For a situation that the products produced contain different processes but the products are similar, when the user places an order and does not specify a certain production process, this platform will prompt a sales end or the user. Because prices may vary, if customization is required, a price may be higher; and if a similar alternative intermediate product (semi-finished product) is selected and can be provided immediately, the price may be lower, making an entire pricing system operate very flexibly.

For many standardized module intermediates involved in products, such as chopped scallions from shallots in food products, the intermediate products can be used as raw materials in another process. The preparation end can set which products belong to such prepared intermediate products according to an actual situation, and conduct separate inventory management. In this way, when producing other products, there is no need to consider the amount of raw materials and production time used for the intermediate products, but only specific intermediate products, operation modes and required quantities need to be selected; and its quantity in inventory and product preparation time have been solved by a separate inventory management system. In this way, an intermediate product can be matched to a template of a preparation list, thereby replacing several processes and accelerating a production speed. The matching process of intermediate products may be automatic, since a preparation process of intermediate products may be interspersed with other non-sequential steps, or if done manually, it may be necessary to read through the whole text to know which can be replaced by existing semi-finished products; and the system can quickly select an intermediate product, and then prompt the preparation end to directly select the intermediate product if there is inventory (the intermediate product of the provided preparation process). A commonly used intermediate product system can be matched, and the preparation end can be directly selected or defined by itself according to actual needs.

When the user selects a template and submits it to the merchant, the platform provides some necessary prompts. The first prompt is that the system matches the intermediate product, and a price of using the intermediate product is lower, prompting the user whether it is willing to select the intermediate product. The user can request that everything be produced according to a process, or the intermediate product mode that is cheaper and faster to prepare can be selected. The second prompt is that there are similar intermediate products that cannot be completely matched. For example, an intermediate product is ordinary chicken soup, but the template selected by the user provides characterized chicken soup with some special spices added; and in this situation, the platform will also prompt the user whether to replace with an existing intermediate product that is cheaper and faster to prepare. This way of replacing standardized module intermediate products in intermediate processes will be matched and confirmed in two directions according to the settings of users and corresponding merchants, and its purpose is to optimize an overall production process and provide users with effective and real product preparation process information.

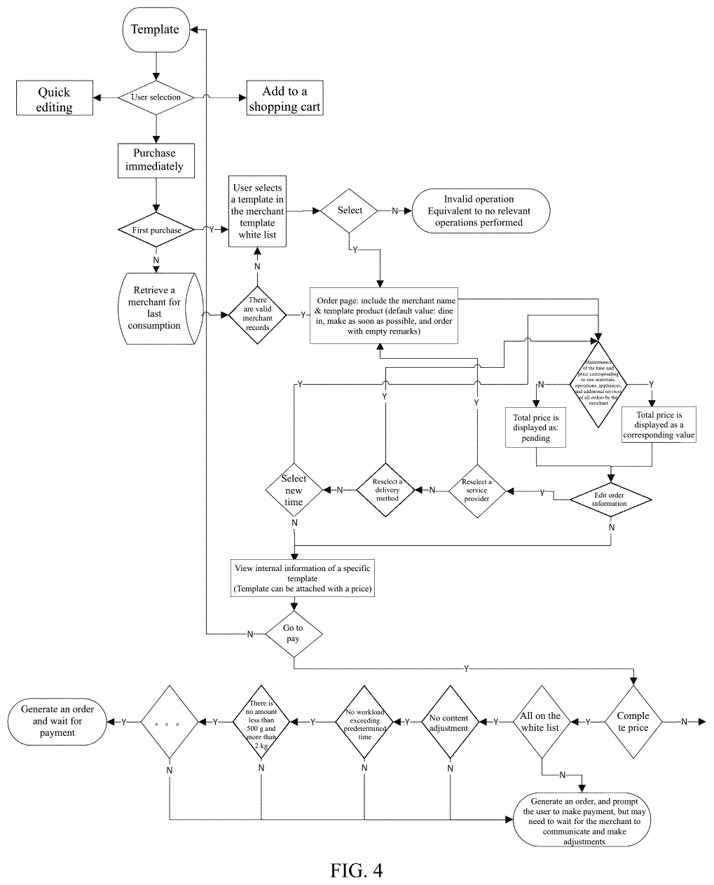

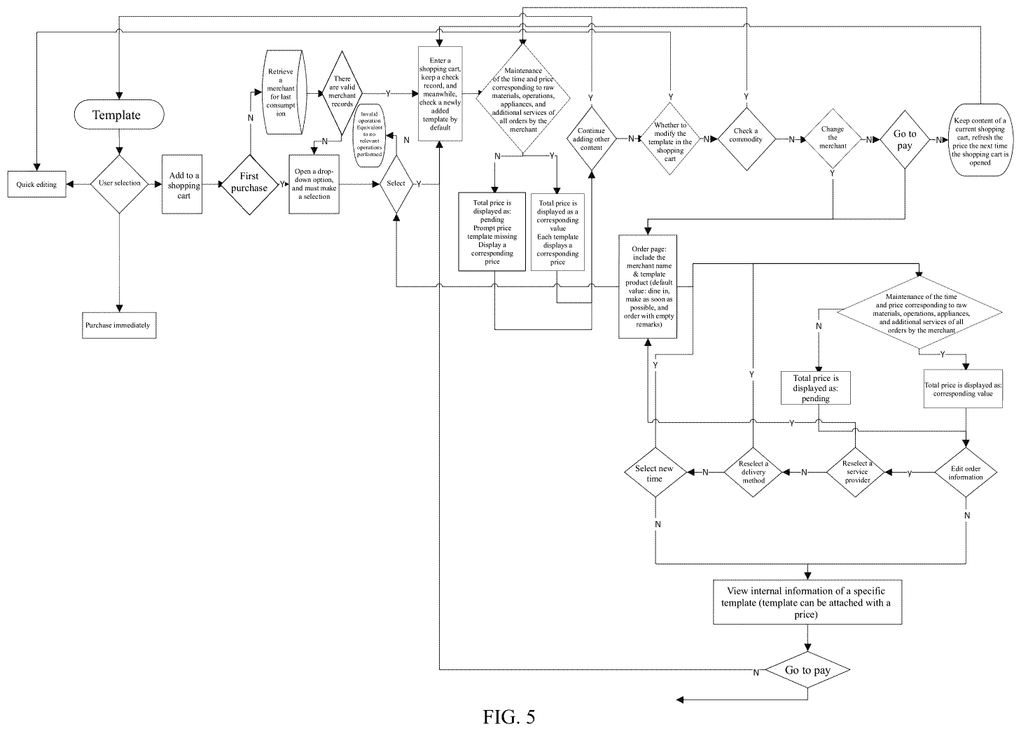

Please refer to FIGS. 4 to 6 at the same time, which are flow charts in which a user selects a product according to a template based on specific embodiments of this technical solution, and include three ways: after user selection, quick editing, immediate purchase, and adding to a shopping cart for subsequent purchase.

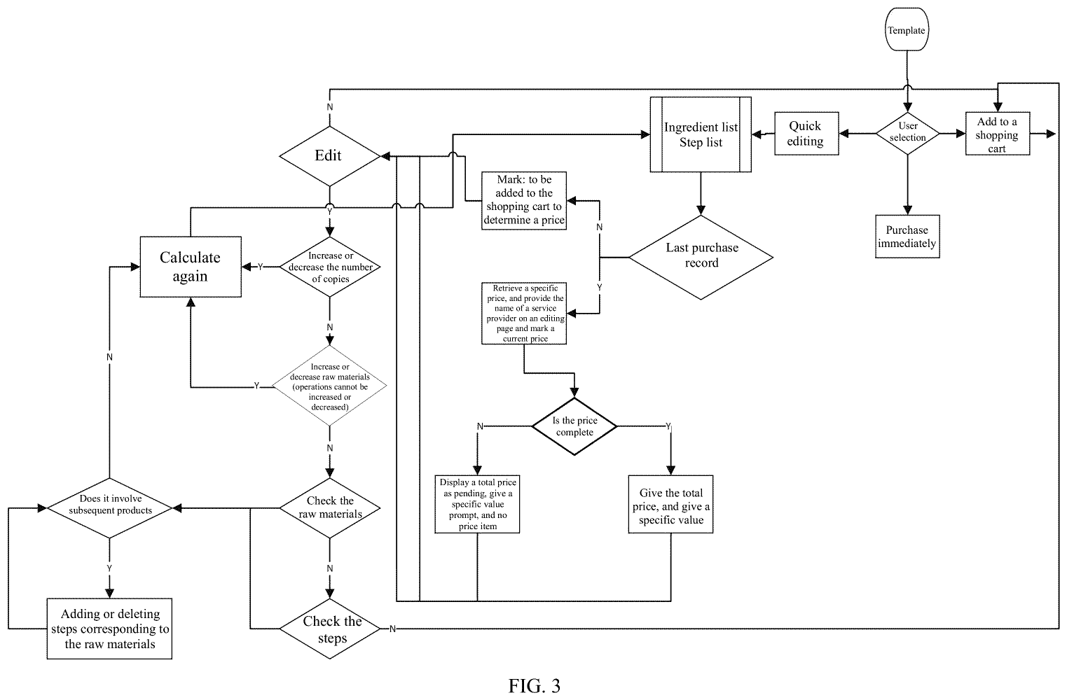

First, in the first way, after the user selects the template, the template is directly selected without modification and is directly purchased. As shown in FIG. 3, the user selects the merchant and the template, and after selection, an order page is formed, and the order page includes the merchant name and template details (default value: dine in, make as soon as possible, and order with empty remarks); and the order page matches specific information maintained by the corresponding merchant, and will be simultaneously transmitted to the merchant for detailed verification and maintenance of content: time, price, etc. corresponding to the order raw materials, operations, appliances or additional services. If a definite total price can be formed, a value corresponding to the total price is displayed. The user can also continue to edit order information, reselect a service provider, reselect a formula, or reselect time. Relevant selection results will be synchronized to the merchant, and the merchant will match or further verify and maintain details of raw materials, operations, appliances, or additional services of the order. If the order is confirmed and no editing is made, the user can view internal details of the selected specific template and select to go to a payment module for payment.

The payment judgment process is as follows: the system judges whether the price is complete or not, and if it is complete and is all in the white list, and there is no content adjustment, there is no workload exceeding predetermined time, and there is no setting of a specific merchant-defined basic preparation limit such as an amount of less than 500 g or more than 2 kg, etc., a payment order is produced and waits for payment. If there is any content that needs to be modified as mentioned above, it is necessary to wait for communication with the merchant to adjust the order before returning to a payment order process.

If the user selects to add to a shopping cart, no payment is made temporarily. Then the second path needs to be selected, as shown in FIG. 4. After the user selects the template, the template is added to a shopping cart; and a corresponding merchant is matched or selected for preparation. After receiving the order, the merchant maintains the current time and price of the raw materials, operations, and appliances for each template of the order. If a total price is displayed as a corresponding value, each template displays a corresponding price. If the total price is displayed as pending and prompts for a price-missing template, the corresponding price will be displayed and the user will be prompted to continue adding other content, returning to the path where the user selects the template. If there is no need to add content, modify the template in the shopping cart, select the commodity separately, or change the merchant, the user proceeds to a payment process. An order page is generated that includes the merchant name and template commodity, and can include default values, delivery, make as soon as possible, or other remark information, etc. The merchant maintains the additional time and price corresponding to the raw materials, operations and appliances of all orders. If the total price is displayed as a corresponding value, there is no need to edit order information, and the user can view internal content of the specific template and enter a payment page. If the total price is displayed as pending and the user needs to reselect a service, or reselect a delivery method or time, the user returns to maintenance of the order by the merchant until a confirmed total value is displayed and enters the payment page. In addition, content of a current shopping cart is kept, the price is refreshed the next time the user opens the shopping cart. If there is a need to add content, modify the template in the shopping cart, check the commodity, or change the merchant, the user returns to the location where the user selects the template and restarts the operation.

The workflow of the payment module is to judge whether the price is complete, and if it is complete, it is judged whether all necessary items such as raw materials and operations are in the white list, there is no content adjustment, there is no workload exceeding predetermined time, and there is no merchant independent setting of less than 500 g or more than 2 kg, etc., then an order is produced and waits for payment. If the above content exists, it is necessary to wait for communication with the merchant to adjust the order.

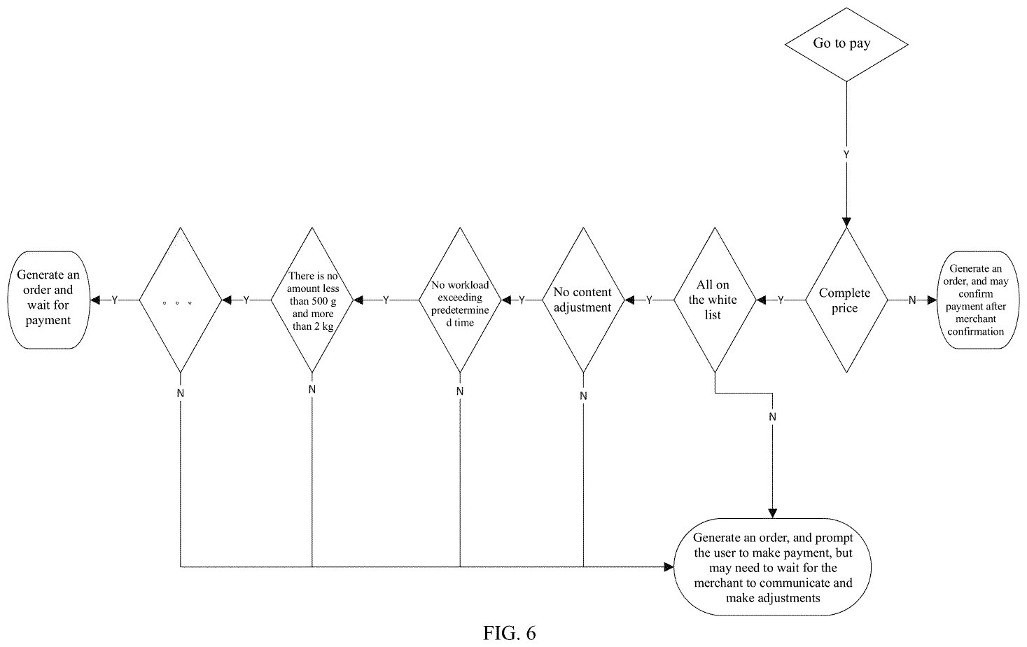

After selecting the template, the user can select the third path for quick editing of the template, as shown in FIG. 6. The system can provide a list of ingredients and a list of steps. If the user selects to purchase, the system retrieves a specific price and provides the name of a service provider on an editing page and marks a current price. The result is checked for completeness. If the price is complete, a total price is given, along with a specific value. If the price is incomplete, the total price is displayed as pending and a specific prompt is given, and the user can enter the editing page. If the user needs to increase or decrease the number of copies and increase or decrease raw materials, corresponding edits can be made, such as checking raw materials and checking steps. After updating, a price will be recalculated. After the system can provide a complete total price, the user enters a shopping cart process and the subsequent payment module for payment.

1. A product ordering system based on a process data processing system, comprising a digital process flow template with a unique identifier, wherein the digital process flow template forms an intermediate product and/or a product from a raw material and an operation stepwise according to a step, and the raw material, the operation and/or the product is stored through a data management module and maintained through a data maintenance module; and a logical relationship between the raw material and the operation is defined by a basic template rule module; and
further comprising a merchant module and a customer module,
the merchant module includes production data information, basic information, management information, an intermediate product white list, and/or a template white list of a merchant, and the template white list includes a plurality of digital process flow templates that are capable of being prepared by the merchant;
the merchant module further comprises a custom manufacturing rule module, comprising a definition of the logical relationship between the raw material and the operation by each specific merchant; and
in the customer module, a customer selects a digital process flow template from one of two paths, i.e., the digital process flow template provided by the system or the digital process flow template in the template white list manufactured by the merchant, and then sends the selected digital process flow template to the merchant module, a product order list is formed after logical relationship is verified by means of the custom manufacturing rule module.

2. The product ordering system based on a process data processing system according to claim 1, further comprising a price module, wherein the price module comprises price information, the price information comprises pricing information related to the raw material comprising: commodity price information, commodity pre-sale ordering information, commodity batch information, commodity supplier information, time-limited price information, and/or an on-demand quotation option; the price information further comprises pricing information related to the operation comprising basic operation pricing, personnel skill pricing, appliance use pricing, and/or special rule pricing; and
the product order list is further matched with the price information in the price module to form a preparable and payable production order.

3. The product ordering system based on a process data processing system according to claim 2, wherein the merchant selects a template based on a resource library, or uploads a new template to form a template white list matched with the merchant, a different template is capable of being selected by a same merchant, and a same template is capable of being selected by a different merchant; and
a user is capable of selecting a template based on the resource library, or uploading a new template, or selecting a template from the template white list of the merchant.

4. The product ordering system based on a process data processing system according to claim 3, wherein the custom manufacturing rule module comprises a definition of the raw material and the operation, and/or the definition of the logical relationship between the raw material and the operation by each specific merchant that is capable of being set through a “rule black list” and/or a “rule white list”.

5. The product ordering system based on a process data processing system according to claim 4, wherein the digital process flow template is capable of forming a branch template after fine-tuning of the raw material and/or the operation, and the branch template is directly sent to the merchant and verified only through the custom manufacturing rule module.

6. The product ordering system based on a process data processing system according to claim 5, wherein the production information of the merchant comprises a raw material white list, an appliance white list, an operation white list, and/or a personnel allocation list.

7. The product ordering system based on a process data processing system according to claim 6, wherein in the custom manufacturing rule module, the raw material comprises three states: present, absent or uncertain; and the operation comprises three states: doable, non-doable and uncertain, wherein the uncertain mode requires further analogy judgment and part of manual verification is finally performed, and meanwhile, a general rule is maintainable as a corresponding rule after the manual verification to help the system to be self-perfected.

8. The product ordering system based on a process data processing system according to claim 7, wherein the system further sets the intermediate product, the merchant module comprises an intermediate product white list, a certain digital process flow template selected by the user comprises an intermediate product capable of replacing a related flow, and the system then prompts the user that the intermediate product is usable to accelerate a preparation process.

9. The product ordering system based on a process data processing system according to claim 8, wherein when the customer module selects a certain digital process flow template in the system, the digital process flow template is automatically matched with content of the merchant to obtain process information on whether the digital process flow template is capable of being prepared, if the user selects to continue, the digital process flow template is sent to the merchant, when the merchant lacks or only has a certain raw material, operation, intermediate product, and/or product, a reservation solution or a replacement solution is capable of being communicated with the customer through a customized service module, and based on a communication result, an order list is formed, wherein the reservation solution comprises a reservation purchasing time interval of a missing item, i.e., when the user selects a corresponding template, preparation time is selected in an order process, and a predetermined time range of the missing item is given.

10. The product ordering system based on a process data processing system according to claim 9, wherein the price information further comprises pricing information related to management, which is a charging item defined by the merchant and comprises a peak hour markup fee, a delivery fee, a venue use fee, a packaging fee, a rent sharing fee, and/or a water and electricity use fee.
